(19) United States
(12) Patent Application Publication
(10) Pub. No.: US 2026/0300084 A1
(43) Pub. Date: Oct. 1, 2026

(54) FAULT DETECTION METHOD AND PROCESSORS

(71) Applicant: Arm Limited, Cambridge (GB)

(72) Inventors: Quenton Michael JONES, Hertfordshire (GB); Simon Alex CHARLES, Cambridge (GB)

(21) Appl. No.: 19/096,930

(22) Filed: Apr. 1, 2025

(51) Int. Cl. G06F 11/08; G06F 11/30

(52) U.S. Cl. CPC G06F 11/08; G06F 11/3024

(57) ABSTRACT

Processors and method of detecting a fault in a processor configured to perform parallel processing. Methods include temporally synchronizing respective schedulers to issue a same processing task to each of at least two parallel processing units substantially simultaneously; executing the same processing task to generate a respective output from each of the parallel processing units; comparing the respective outputs; and determining, responsive to a difference being detected between the respective outputs, that a fault is present. Processors include at least two parallel processing units, each including a respective scheduler being temporally synchronizable to issue a same processing task to each respective parallel processing unit substantially simultaneously; the parallel processing units being configured to execute the same processing task to each generate a respective output; and comparison circuitry configured to compare the respective outputs to determine, responsive to a difference being detected between the respective outputs, that a fault is present.

### FIELD

The present invention relates to processors and machine implemented methods of detecting a fault in a processor.

### BACKGROUND

Processors, such as graphics processing units (GPUs), are used in a wide variety of safety critical situations. As an example, connected autonomous vehicles use GPUs to process data and make decisions relating to autonomous driving functionality.

Some processors may experience performance issues, for example, developing transient or permanent faults which may impact processing.

Existing detection systems and methods detect such performance issues at a system or sub-system level, e.g., indicating an entire processor is experiencing issues. As a result, safety critical systems generally rely on redundancy, often by providing a redundant processor or plurality of processors, to mitigate performance issues.

The present techniques relate to advancements in fault detection precision for processors.

### SUMMARY

According to a first approach of present techniques, there is provided a machine implemented method of detecting a fault in a processor configured to perform parallel processing, the processor comprising at least two parallel processing units, the method comprising: temporally synchronizing respective schedulers of each of the at least two parallel processing units to issue a same processing task to each of the at least two parallel processing units substantially simultaneously; issuing, using the respective schedulers, the same processing task to each of the at least two parallel processing units substantially simultaneously; executing, using each of the at least two parallel processing units, the same processing task to generate a respective output from each of the at least two parallel processing units; comparing, using comparison circuitry, the respective outputs; and determining, responsive to a difference being detected between at least two of the respective outputs, that a fault is present in the processor.

In some implementations, the processor further comprises at least one non-parallelized fixed function processing circuit comprising circuitry configured to operate substantially in series with each of the at least two parallel processing units of the processor to perform processing tasks corresponding to a fixed function.

In some implementations, the method further comprises comparing, using the comparison circuitry, respective inputs to the non-parallelized fixed function processing circuit from each of the at least two parallel processing units; and determining, responsive to a difference being detected between the respective inputs to the non-parallelized fixed function processing circuit, that a fault is present in the processor.

In some implementations, the method further comprises comparing, using the comparison circuitry, respective outputs from the non-parallelized fixed function processing circuit to each of the at least two parallel processing units; and determining, responsive to a different being detected between the respective outputs from the non-parallelized fixed function processing circuit, that a fault is present in the processor.

In some implementations, the method further comprises identifying that the fault is a permanent fault by: issuing, using the schedulers, a diagnostic task to each of the at least two parallel processing units; executing, using each of the at least two parallel processing units, the diagnostic task to generate a respective diagnostic output from each of the at least two parallel processing units; comparing, using comparison circuitry, the respective diagnostic outputs; and determining, responsive to a difference being detected between at least two of the respective diagnostic outputs, that the fault is a permanent fault.

In some implementations, the diagnostic task comprises a pseudorandom stimulus generated by a pseudorandom stimulus generator and configured to, when executed by each of the at least two parallel processing units, exercise a majority of the circuitry of each of the at least two parallel processing units.

In some implementations, the method further comprises tuning at least one parameter of the pseudorandom stimulus generator based on at least one attribute of the processing task to generate a skewed pseudorandom stimulus to bias the diagnostic task towards the processing task.

In some implementations, the at least one attribute of the processing task is one or more selected from the list: an instruction type; an instruction class.

In some implementations, the pseudorandom stimulus generator is tuned based on the processing task in response to determining that a number of times that a fault has been detected during a predetermined time period exceeds a predetermined threshold.

According to a further approach of present techniques, there is provided a processor configured to perform parallel processing, the processor comprising: at least two parallel processing units, each parallel processing unit comprising a respective scheduler; the respective schedulers being temporally synchronizable to issue a same processing task to each respective one of the at least two parallel processing units substantially simultaneously; the parallel processing units being configured to execute the same processing task to each generate a respective output; and comparison circuitry configured to compare the respective outputs to determine, responsive to a difference being detected between at least two of the respective outputs, that a fault is present in the processor.

In some implementations, the processor is dynamically re-configurable between: a safety critical configuration, in which the respective schedulers are temporally synchronized to issue a same safety critical processing task to each respective one of the at least two parallel processing units substantially simultaneously; and a non-safety critical configuration, in which the respective schedulers are not temporally synchronized and are configured to issue respective non-safety critical processing tasks to the respective parallel processing units, and in which the respective outputs are not compared by the comparison circuitry.

In some implementations, the at least two parallel processing units each comprise programmable processing circuitry operable to execute programs to perform processing tasks.

In some implementations, the processor comprises a first execution core comprising the at least two parallel processing units, and a further execution core comprising a further at least two parallel processing units; the first execution core being configured to operate substantially in parallel with the further execution core to substantially simultaneously execute respective processing tasks of a processor workload.

In some implementations, the processor comprises a first execution module comprising the first execution core and the second execution core, and a second execution module comprising at least two further execution cores; the first execution module being configured to operate substantially in parallel with the second execution module to substantially simultaneously execute respective processing task streams of the processor workload.

In some implementations, the processor comprises a command stream execution unit configured to issue commands relating to processing tasks to cause the processing tasks indicated by the commands to be distributed to the schedulers of each of the at least two parallel processing units.

In some implementations, the at least two parallel processing units comprises a primary parallel processing unit and a secondary parallel processing unit; the primary parallel processing unit being configured to transmit, responsive to no difference being detected between the respective outputs of the primary parallel processing unit and the secondary parallel processing unit, a message comprising the respective output of the primary parallel processing unit to storage.

In some implementations, the message further comprises a fault-free indicator.

In some implementations, the at least two parallel processing units further comprises a tertiary parallel processing unit; the primary parallel processing unit being configured to transmit, responsive to no difference being detected between the respective outputs of the primary parallel processing unit and one other of the secondary parallel processing unit and the tertiary parallel processing unit, a message comprising the respective output of the primary parallel processing unit to storage.

According to a further approach of present techniques, there is provided a reconfigurable processor configured to perform parallel processing and operable to be reconfigured between a safety critical configuration and a non-safety critical configuration, the processor comprising: at least two parallel processing units, each parallel processing unit comprising a respective scheduler; wherein, in the non-safety critical configuration, the respective schedulers are configured to issue respective non-safety critical processing tasks to the respective parallel processing units for execution; and wherein, in the safety critical configuration: the respective schedulers are temporally synchronized to issue a same safety critical processing task to each respective one of the at least two parallel processing units substantially simultaneously; the parallel processing units are configured to execute the same processing task to each generate a respective output; and comparison circuitry is configured to compare the respective outputs to determine, responsive to a difference being detected between at least two of the respective outputs, that a fault is present in the reconfigurable processor.

In some implementations, the processor is further operable to be reconfigured into a diagnostic configuration; wherein, in the diagnostic configuration, the respective schedulers are configured to issue a same diagnostic task to each of the at least two parallel processing units for execution; the diagnostic task comprising a predetermined stimulus configured to, when executed by each of the at least two parallel processing units, exercise a majority of the circuitry of the parallel processing units.

### BRIEF DESCRIPTION OF THE DRAWINGS

Implementations of the present invention will now be described by way of example only and with reference to the accompanying drawings, in which:

FIG. 1 provides a block diagram of a core of a processor according to an approach of present techniques;

FIG. 2 provides a block diagram of a core of a processor according to an approach of present techniques;

FIG. 3 provides a block diagram of a processing unit of a core of a processor according to an approach of present techniques;

FIG. 4 provides a block diagram of a processor according to an approach of present techniques;

FIG. 5 provides a flowchart of a method according to a further approach of present techniques;

FIG. 6 provides a further flowchart of a method according to a further approach of present techniques; and

FIG. 7 provides a flowchart of a method according to a further approach of present techniques.

### DETAILED DESCRIPTION

Generally, a processing unit of a processor cannot continue to operate after it has suffered a permanent hardware fault; the processing unit is failed. In general, occurrence of the first permanent fault is unpredictable; where and when it will arise is not known. In many applications, particularly safety critical applications, such unpredictability is mitigated by provision of a large quantity of redundant resources so that at least some processing may continue after a permanent fault occurs.

For example, after suffering a permanent fault, modern highly autonomous vehicles must remain operational for at least the duration of the current drive-cycle (e.g., ~1 day). Presently, this requirement is addressed by installing an entire reserve (or surplus) processor that is idle unless and until the primary processor fails and, in some cases, a further reserve pair of processors.

Approaches according to present techniques exploit the modular architecture of certain processors to provide a processor that is capable of self-diagnosis to detect and pinpoint a location of a fault in the processor. In this way, the specific failed or faulty resources of the processor may be disabled while the rest of the processor may remain operational. As such, a need to provide redundant processors is reduced and efficiency is improved. In exchange for a modest reduction in processing efficiency within one processor, provision of redundant processor(s) may be avoided.

A processor may have a plurality of identical processing units, where each processing unit is capable of independent processing and so is assigned tasks by a scheduler according to dynamic changes in load. To isolate a failed processing unit from healthy units, the fault must be detected and the failed unit must be identified. Present techniques synchronize issuance and execution of duplicate processing tasks across a plurality of processing units and compare results to detect a fault in any one processing unit. By distributing the fault detection capabilities to the processing units themselves, each processing unit may report its health or the detection of a fault.

Once a fault is reported, mitigation action may be taken, for example to disable the faulty unit or modify which processing tasks are allocated to it. In this way, the processor may continue in normal safe operation using the remaining fault-free resources. As such, present techniques provide that the processor be able to self-diagnose faults to allow informed resource management and targeted resource use. In this way, the present techniques may contribute to enabling a processor to continue operating despite experiencing a permanent fault.

Present techniques are particularly relevant to graphics processing units, GPUs, as those processors generally comprise highly modular parallelized architectures, dynamic control over modular resources and a majority of the hardware within the modular parallel processing components. As the non-modular components make up a non-majority, or minority, proportion of the GPU hardware, a likelihood of common cause failure, i.e., a fault occurring in the non-modular components, is relatively small.

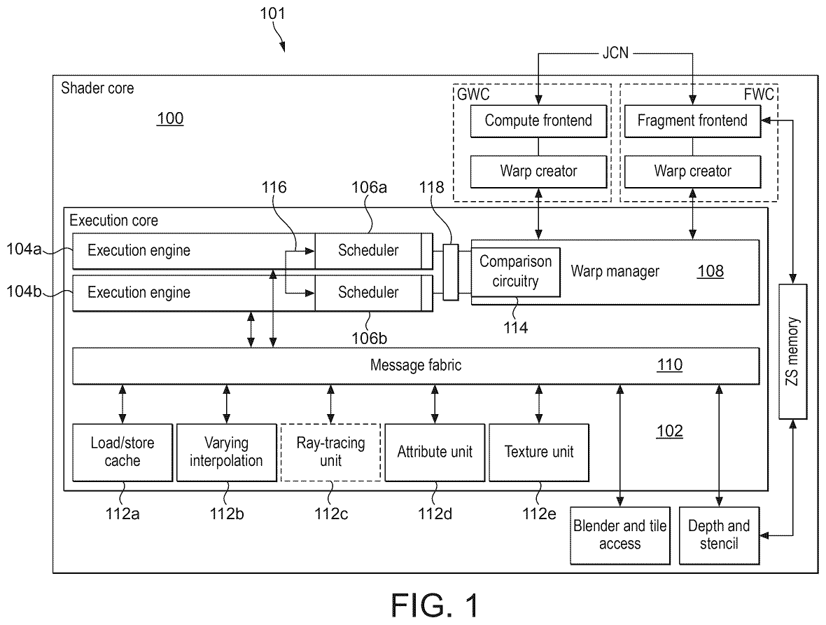

With reference to FIG. 1, there is illustrated a core 100 of a processor 101 configured to perform parallel processing according to an approach of present techniques. The core 100 is a shader core 100 in the implementation shown in FIG. 1. The shader core 100 comprises an execution core 102. The execution core 102 comprises two execution engines 104a, 104b constituting parallel processing units. Each execution engine 104a, 104b comprises a scheduler 106a, 106b.

The execution engines 104a, 104b are configured to execute processing tasks in parallel with one another, that is, at the same time as each other. The schedulers 106a, 106b are temporally synchronizable to issue a same processing task to each of the execution engines 104a, 104b substantially simultaneously. The schedulers 106a, 106b may communicate with one another to achieve temporal synchronization. For example, the schedulers 106a, 106b may be connected by a wire or wires 116. The execution engines 104a, 104b execute the same processing task to each generate a respective output. The comparison circuitry 114 is configured to compare the respective outputs to determine whether a fault is present in the processor. In particular, if a difference is detected between the respective outputs, it may be determined that a fault is present in the processor.

The processor 101 is therefore capable of self-diagnosis of faults. In other words, the processor 101 itself is complete with all the components required to detect that a fault is present in an execution engine 104a, 104b of the processor 101. Further, the processor 101 is able to pinpoint a location of the fault to a specific shader core 100 and specific execution core 102 of the processor 101. In this way, when a fault is detected and pinpointed, the rest of the processor 101 may continue to operate as normal while the affected execution core 102 is disabled. Further, in this way a fault leading to a corrupt output is detected and may be mitigated as soon as the corrupt output is generated; the corruption is detected before propagation throughout the system. In this way the processor provides accurate and rapid fault detection for effective mitigation and improved accuracy and reliability of processing.

By being able to detect and pinpoint its own faults, the processor 101 is suitable for use as a safety critical processor 101. A safety critical processor 101 may be configured to carry out safety critical processing. During safety critical processing, faulty operation of the processor 101 may risk a high severity outcome, e.g., endangering life or property. For example, faulty processing of camera data in an adaptive cruise control system in a vehicle may cause a collision. By being capable of self-diagnosis of faults, faulty processing may be mitigated and the processor 101 may be suitable for use in safety critical processing.

The execution core 102 of FIG. 1 further comprises a warp manager 108, message fabric 110 and a plurality of non-parallelized units 112a, 112b, 112c, 112d, 112e. The non-parallelized units 112a-e may comprise non-parallelized fixed function processing circuits 112a-e configured to operate substantially in series with each of the execution engines 104a, 104b of the processor 101 to perform processing tasks corresponding to a fixed function. The non-parallelized fixed function processing circuits 112a-e may be known as ancillary circuits. As examples of fixed function processing units, the non-parallelized units may comprise a load/store cache 112a, a varying interpolation unit 112b, a ray-tracing unit 112c, an attribute unit 112d and a texture unit 112e.

The warp manager 108 may comprise the comparison circuitry 114. The execution engines 104a, 104b may communicate with the non-parallelized units 112a-e via the message fabric 110. The execution engines 104a, 104b may also each communicate with the warp manager 108.

The comparison circuitry 114 may be configured to compare respective inputs to a non-parallelized fixed function processing circuit 112a-e from each of the execution engines 104a, 104b. Further, the comparison circuitry 114 may be configured to compare respective outputs from the non-parallelized fixed function processing circuit 112a-e to each of the execution engines 104a, 104b. In this way, by detecting a difference between the respective inputs to and/or outputs from the non-parallelized fixed function processing circuit 112a-e, it may be determined that a fault is present in the shader core 100 of the processor 101. In this way, faults in non-parallelized units of a core 100 may be detected using the ideas of the present techniques.

In the implementation of FIG. 1, the core 100 further comprises a conversion circuit 118. The conversion circuitry 118 is configured to convert the respective outputs from the execution engines 104a, 104b into respective output hashes for comparison by the comparison circuitry 114 of the warp manager 108. By converting the respective outputs to respective output hashes using a conversion circuit 118, the work of comparison, using comparison circuitry 114, may be simplified. In this way, an efficiency of the processor 101 may be increased.

The processor 101 may be configured to operate in one of a plurality of configurations.

In other words, the core 100 may be reconfigured during operation substantially without interruption, i.e., without a reboot or rebuild for example. In this way, the processor 101 may be versatile to execute safety critical tasks or to execute non-safety critical tasks, prioritising accuracy or efficiency respectively, as appropriate in a highly convenient manner by dynamic reconfiguration of individual cores 100.

Specifically, the processor 101 may be dynamically re-configurable between a safety critical configuration and a non-safety critical configuration. In the safety critical configuration, the core 100 of FIG. 1 may be configured to execute safety critical processing tasks. Accordingly, in the safety critical configuration, the schedulers 106a, 106b may be temporally synchronized to issue a same safety critical processing task to each of the execution engines 104a, 104b substantially simultaneously. As discussed above, the respective outputs from the execution engines 104a, 104b executing the task are compared by the comparison circuitry 114 to confirm no faults are present before one of the respective outputs is transmitted out of the core 100, e.g., to storage. As the output is confirmed to be fault-free, the processor 101 is suitable for use in safety critical applications to process safety critical processing tasks.

In the non-safety critical configuration, the core 100 of FIG. 1 may be configured to execute non-safety critical processing tasks. Accordingly, the core 100 may be configured in a non-safety critical configuration in which the schedulers 106a, 106b are not temporally synchronized, each scheduler 106a, 106b is configured to issue respective non-safety critical processing tasks to the respective execution engine 104a, 104b without regard for any other execution engine 104a, 104b and the respective outputs are not compared by the comparison circuitry 114. Accordingly, in the non-safety critical configuration, the processor may operate efficiently with each execution engine processing a respective task; without duplication.

The core 100 of FIG. 1 may be dynamically re-configurable between the safety critical configuration and the non-safety critical configuration or configurable between the safety critical configuration and the non-safety critical configuration on reset of the core 100. Reset of the core 100 may incur a short delay between processing tasks. In this way, the same processor may operate in a safety critical and a non-safety critical way.

As discussed above, the shader core 100 of the processor 101 may be configured to execute safety critical processing tasks. Contemporaneously, other cores 100 of the processor 101 may be configured to execute non-safety critical processing tasks. For example, a first group of cores 100 of the processor 101, may be configured to execute safety critical processing tasks while a second group of cores 100 may be configured to execute non-safety critical processing tasks. The groups of cores 100 may each be slices, groups of slices, or partitions of a processor 101. In such an implementation, the parallel processing units (execution engines) of cores 100 executing non-safety critical processing tasks may each be issued different tasks by their respective schedulers for efficiency of processing, while at least two of the parallel processing units of a core 100 executing safety critical processing tasks are each issued the same task by their respective temporally synchronized schedulers for fault detection. In some implementations, all cores 100 of the processor 101 are configured to execute safety critical processing tasks.

One of the execution engines 104a, 104b may be a primary execution engine 104a while another of the execution engines 104a, 104b may be a secondary execution engine 104b. The primary parallel execution engine 104a may be configured to transmit, responsive to no difference being detected between the respective outputs of the execution engines 104a, 104b, a message comprising the respective output of the primary execution engine 104a to storage. The message may comprise a fault-free indicator.

In this way, a respective output from one of the execution engines 104a, 104b is configured to be transmitted out of the core 100, e.g., to storage or for onward processing, while other respective output is generated for comparison only. Examples of outputs configured to be transmitted out of the core 100 include store operations, atomic operations and other operations involving writing to storage.

Where an output of the primary execution engine 104a is configured to be transmitted out of the core 100, the primary execution engine 104a may experience more latency than secondary execution engine 104b. In this way, the secondary execution engine 104b may be available to receive a further processing task from the respective scheduler 106b before the primary execution engine 104a. As such, if not synchronized according to present techniques, the secondary execution engine 104b may quickly outpace the primary execution engine 104a. In this case, a large amount of storage may be required to store the respective outputs of the secondary execution engine 104b until the corresponding respective output of the primary execution engine 104a is available for comparison. Alternatively, the execution engines 104a, 104b may become so far unsynchronized as to make comparison of the respective outputs impossible. Accordingly, temporal synchronization of the schedulers 106a, 106b allows efficient fault detection with minimal storage requirements.

The plurality of execution engines 104a, 104b arranged in parallel may comprise at least three execution engines; a primary, secondary and tertiary execution engine. Respective outputs of each of the primary, secondary and tertiary execution engines may be provided to the comparison circuitry for comparison. The comparison circuitry may find that all three respective outputs match, two out of three respective outputs match or none of the respective outputs match.

In the first case, all the execution engines agree, there is a very low chance of an error being present. So, the primary execution engine 104a may be configured to transmit a message comprising the respective output of the primary execution engine 104a to storage. A fault-free indicator may also be provided in the message.

In the second case, two of three execution engines agree, it is possible that a fault is present in the execution engine responsible for the outlying respective output. However, there is a low chance an error being present in the two agreeing execution engines. In this way, a voting system may be implemented where three or more execution engines execute the same processing task according to present techniques. In a voting system, each execution engine may cast a vote (i.e., their respective output) and a simple majority, i.e., >50%, may be required to cause the ‘winning’ respective output to be transmitted to storage. The voting system may be implemented by a voting circuit forming part of the comparison circuitry.

Accordingly, responsive to no difference being detected between the respective outputs of the primary execution engine 104a and one other of the secondary execution engine 104b and the tertiary execution engine, the primary execution engine 104a may be configured to transmit a message comprising the respective output of the primary execution engine 104a to storage. In this way, a fault in just one execution engine may not cause a loss of data and may not interrupt operation of the processor 101 as a fault-free output may still be provided if a majority (e.g., two of three) respective outputs are equal. In this case, the message may also include a fault indicator, e.g., indicating that the output is fault free but that a latent fault is detected in the core 100, as there was not unanimous agreement between the execution engines.

In the third case, no agreement between execution engines, there can be no determination that any of the execution engines are fault-free. Accordingly, none of the execution engines may transmit their respective outputs to storage. Instead, a fault detected message may be sent. The fault detected message may comprise a multi-fault indicator configured to indicate that more than one fault may be present in the core 100. In this way, a granularity of fault reporting may be increased.

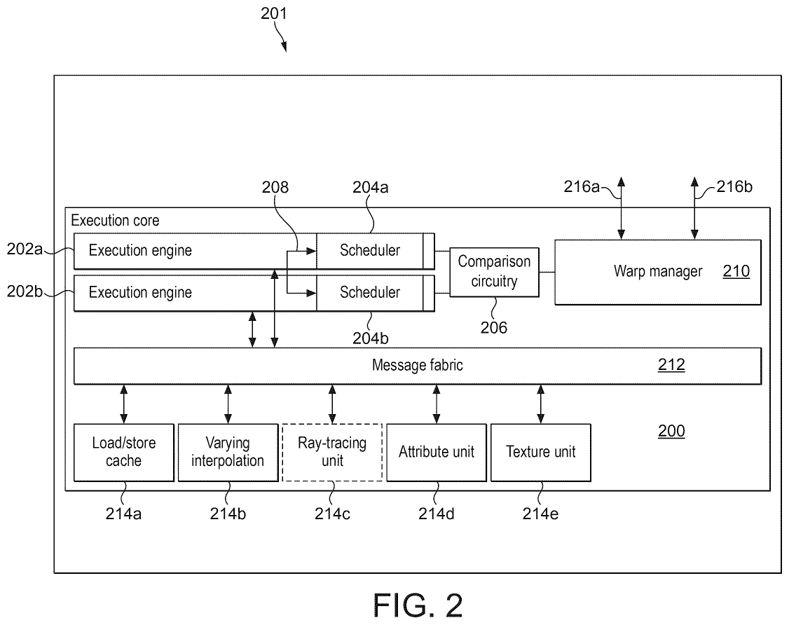

With reference to FIG. 2, there is illustrated a core 200 of a processor 201 configured to perform parallel processing according to a further approach of present techniques.

The processor 201 of FIG. 2 is a reconfigurable processor 201 operable to be reconfigured between a safety critical configuration and a non-safety critical configuration. The processor 201 comprises an execution core 200. The execution core 200 comprises two execution engines 202a, 202b. Each execution engine 202a, 202b comprises a scheduler 204a, 204b.

In the non-safety critical configuration, each scheduler 204a, 204b is configured to issue respective non-safety critical processing tasks to the respective execution engine 202a, 202b for execution.

In the safety critical configuration, the schedulers 204a, 204b are temporally synchronized to issue the same safety critical processing task to each of the execution engines 202a, 202b substantially simultaneously. Also in the safety critical configuration, the execution engines 202a, 202b execute the same processing task to each generate a respective output. Then, comparison circuitry 206 of the execution core 200 is configured to compare the respective outputs to determine, responsive to a difference being detected between at least two of the respective outputs, that a fault is present in the execution core 200 of the reconfigurable processor 201.

While operating in safety critical mode, half of the execution engines 202a, 202b of each execution core 200 are occupied with duplicate processing for the purposes of comparison. In a typical processor 201, as much as 90% of the processing resource of the execution core 200 may be execution engines 202a, 202b and so, during safety critical processing, as much as 45% of the processing resource may be performing duplicate work for comparison purposes. By contrast, in non-safety critical processing, all the processing resources (execution engines 202a, 202b) of the execution core 200 are engaged in executing different tasks. Accordingly, non-safety critical processing may be substantially faster than safety critical processing, e.g., around double speed.

During non-safety critical processing, a fault in an execution engine 202a, 202b is not detectable by present techniques because there is no step of comparison to determine presence of a fault. As such, faults may propagate unchecked. This may be acceptable in non-safety critical processing and may, for example, be detected periodically by a logic built-in self-test protocol. By providing a method of fault detection for the parallelized units, i.e., the execution engines 202a, 202b, of execution core 200, a high proportion of potential faults in the processor 201 are detectable. In particular, as execution engines 202a, 202b may make up as much as 90% of the processing resource of the execution core 200, as much as 90% fault coverage may be achieved. As such, a vast majority of faults in the processor 201 may be detected and mitigated in a safety critical configuration.

The schedulers 204a, 204b may communicate with one another to achieve temporal synchronization. For example, the schedulers 204a, 204b may be connected by a wire 208.

The core 200 may comprise a warp manager 210, message fabric 212, a load/store cache 214a, a varying interpolation unit 214b, a ray-tracing unit 214c, an attribute unit 214d and a texture unit 214e. The execution engines 202a, 202b communicate with warp manager 210 directly. The execution engines 202a, 202b communicate with the non-parallelized units 214a-e via the message fabric 212. The warp manager 210 sends messages out of the core 200 via communications interfaces 216a, 216b.

The core 200 of the processor 201 may also be reconfigurable to operate in a diagnostic configuration. In the diagnostic configuration, the schedulers 204a, 204b are configured to issue the same diagnostic task to each of the execution engines 202a, 202b for execution. The diagnostic task may comprise a predetermined stimulus configured to, when executed by each of the execution engines 202a, 202b, exercise a majority of the circuitry of the execution engines 202a, 202b.

The execution engines 202a, 202b may each generate a respective diagnostic output on execution of the same diagnostic task. Comparison of the respective diagnostic outputs by the comparison circuitry 206 may enable determination that a fault is present, or that a reproduced fault is a permanent fault, e.g., responsive to a difference being detected between the respective diagnostic outputs. That is, once a first fault is detected and the core 200 is reconfigured into the diagnostic configuration, if the fault is reproduced during execution of the diagnostic task, it may be determined that the fault is permanent and the core 200 is failed. Alternatively, comparison of the respective diagnostic outputs by the comparison circuitry 206 may enable determination that no fault is detected and the core 200 may continue to be used safely.

In this way, a fault may be characterised, or substantially fault-free operation of the core 200 may be verified. The processor 201 may be re-configured into the diagnostic configuration on detection of a fault. In this way, the diagnostic task may be executed to determine if the fault is transient or permanent. In other implementations, the processor 201 may be re-configured into the diagnostic configuration on detection of a permanent fault. In this way, the diagnostic task may be executed to determine the extent of the permanent fault. In other implementations, the processor 201 may be re-configured into the diagnostic configuration periodically. In this way, the diagnostic task may be executed to verify fault-free operation of the core 200.

Where the diagnostic task is a predetermined stimulus, a correct result of the task may also be predetermined, i.e., known in advance. Accordingly, once the execution engines 202a, 202b have executed the diagnostic task the respective outcomes may be compared against the known correct result to determine which of the parallel processing units is faulty.

Where the diagnostic task comprises a pseudorandom stimulus generated by a pseudorandom stimulus generator, the stimulus may be configured to, when executed by each execution engine 202a, 202b, exercise a majority of the circuitry of each of the execution engines 202a, 202b. The pseudorandom stimulus generator may be tuned to generate a skewed pseudorandom stimulus. For example, a parameter of the generator may be tuned based on an attribute of the processing task to bias the diagnostic task towards the processing task. In this way, the diagnostic task may have a high chance of detecting (i.e., replicating or reproducing) a fault found during execution of the processing task. In this way, an effectiveness of the diagnostic task may be improved.

The pseudorandom stimulus generator may be tuned based on an instruction type of the processing task. For example, the instruction type of the processing task may be float arithmetic, integer arithmetic, load/store, texturing, or any other suitable instruction type.

In another example, the pseudorandom stimulus generator may be tuned based on an instruction class of the processing task. Processing tasks may be categorized into instruction classes, or groups, based on which processing resource(s) are required to execute the processing task. In other words, for diagnosis of a fault detected during execution of a particular processing task, the generator may be tuned based on which hardware units of the processor are involved in executing the processing task. The generator may be tuned towards units involved in executing the processing task and away from units not involved in executing the processing task.

Where a plurality of faults have been detected but an unbiased diagnostic task has found no fault, any correlation between attribute(s) of the processing tasks being executed when the faults were detected may be used to tune the pseudorandom stimulus generator. For example, where a significant proportion (e.g., all, a majority, or more than one) of the faults were detected on execution of processing tasks having a same mode, state, instruction, bit, datatype, or any other suitable attribute, the pseudorandom stimulus generator may be tuned based on that shared attribute.

In some cases, the diagnostic task comprising the pseudorandom stimulus may be unbiased initially. In this way, broad coverage of the circuitry of the execution engines 202a, 202b may be achieved. The diagnostic task may only be biased under special circumstances, e.g., if it is determined that a number of times that a fault has been detected in the core 200 during a predetermined time period exceeds a predetermined threshold. In this way, an intermittent fault may be more likely to be replicated in the diagnostic configuration.

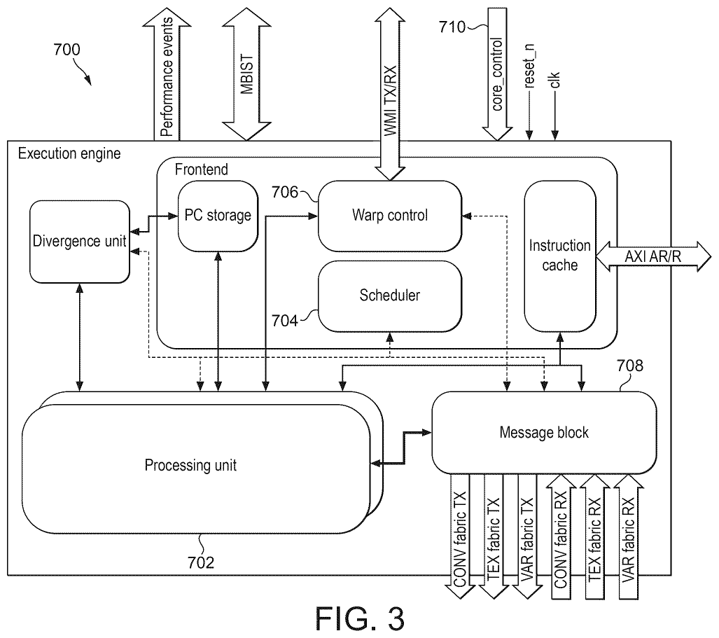

With reference to FIG. 3, there is there is illustrated a processing engine 700 of a processor according to a further approach of present techniques. The processing engine 700 may be an execution engine, such as the execution engines 104a, 104b of the core 100 of FIG. 1 or the execution engines 202a, 202b of the core 200 of FIG. 2. The processing engine 700 may comprise programmable processing circuitry operable to execute programs to perform processing tasks, as may the execution engines 104a, 104b of FIG. 1 or the execution engines 202a, 202b of FIG. 2. For example, the processing engine 700 may form part of a graphics processing unit.

The parallel processing engine 700 comprises a plurality of component parts. The engine 700 comprises dedicated processing circuitry, processing units 702, and a scheduler 704. The scheduler 704 is configured to be temporally synchronized with another such scheduler of a separate unit to issue, substantially simultaneously, a same processing task to the processing circuitry 702 and the processing circuitry of the separate unit, respectively.

The processing circuitry 702 of FIG. 3 is configured to execute the processing task to generate an output.

The output is provided to comparison circuitry, disposed outside the engine 700, in the core. The comparison circuitry is also configured to receive an output generated by the separate unit. The comparison circuitry is configured to compare the received outputs to determine, responsive to a difference being detected between the outputs, that a fault is present in at least one of the engines 700 of the core.

As shown in FIG. 3, the processing engine 700 may comprise a plurality of units of processing circuitry 702 arranged in parallel. The comparison circuitry may be disposed in the warp control unit 706. When an output of the processing engine 700 is determined not to comprise a fault, it may be transmitted out of the processing engine 700 via the message block 708. The schedulers 704 may be synchronized by receiving control signals, e.g., from synchronization circuitry, via the core control bus 710.

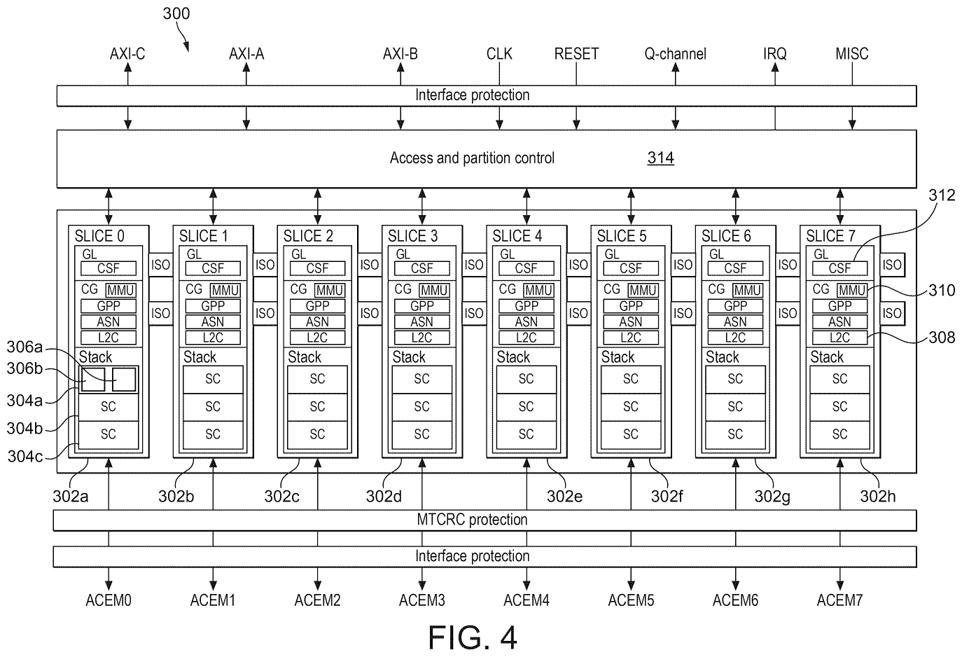

With reference to FIG. 4, there is illustrated a processor 300 according to an approach of present techniques. The processor 300 may be a graphics processing unit, GPU. The processor 300 comprises eight processing slices 302a-h. Each slice 302a-h comprises three cores 304a-c (labelled on one slice only in FIG. 4 for clarity). Each core 304a-c may correspond to the core 100 of FIG. 1 or the core 200 of FIG. 2. Each core 304a-c may comprise a plurality of execution engines 306a, 306b (shown on one core 304a only in FIG. 4 for clarity). Each execution engine 306a, 306b may correspond to the processing engine 700 of FIG. 3, comprising programmable processing circuitry operable to execute programs to perform processing tasks.

The three cores 304a-c may be configured to operate substantially in parallel to substantially simultaneously execute respective processing tasks of a processor workload. The eight processing slices 302a-h may be configured to operate substantially in parallel to substantially simultaneously execute respective processing task streams of the processor workload. A task stream may comprise a plurality of tasks. A workload may comprise a plurality of task streams.

Each slice further comprises a plurality of non-parallelized modules, such as a cache 308, a memory management unit 310 and a front end 312. The front end 312 may constitute a command stream execution unit 312 configured to issue commands relating to processing tasks to cause the processing tasks indicated by the commands to be distributed to the schedulers of each of the execution engines 306a, 306b. Each slice 302a-h is configured to communicate with other components of the processor 300 and out of the processor 300 via an access manager 314.

The processor 300 comprises a plurality of cores 304a-c comprising a plurality of execution engines 306a, 306b. In this way, one processor 300 is made up of a large number of parallel processing components, i.e., slices 302a-h, cores 304a-c, engines 306a, 306b. As such, the ideas of synchronized task issuing, duplicated task executing and comparison of outputs to detect faults may be applied to any processing component at any level of the processor 300. For example, at least two cores 304a-c may be synchronized and configured to execute identical processing substantially simultaneously, enabling comparison of outputs to detect faults in a slice 302a-h. In this way, faults in non-parallelized units of a core 304a-c may be detected using the ideas of the present techniques.

Further, at least two slices 302a-h may be synchronized and configured to execute identical processing substantially simultaneously, enabling comparison of outputs to detect faults in a processor 300 or partition (group of slices 302a-h). In this way, faults in non-parallelized units of a slice 302a-h, e.g., the cache 308, memory management unit 310 a front end 312, may be detected using the ideas of the present techniques.

In the implementation of FIG. 4, the at least one core 304a-c comprises a plurality of parallel processing cores 304a-c, each core 304a-c comprising at least two execution engines 306a, 306b. Further, cores 304a-c may be grouped into slices 302a-h. In this way, the processor 300 comprises a plurality of levels of parallel processing components. For example, a processor 300 may comprise eight slices 302a-h each comprising three cores 304a-c each comprising two execution engines 306a, 306b. The processor 300 may be partitioned into groups of slices 302a-h called partitions configured to execute independent workloads. For example, a first partition of slices 302a-h may execute non-safety critical processing tasks while a second partition of slices may execute safety critical processing tasks.

As discussed above, a first group of processing resources of the processor 300, may be configured to execute safety critical processing tasks while a second group of processing resources may be configured to execute non-safety critical processing tasks. The groups of processing resources may each be engines 306a, 306b, cores 304a-c, slices 302a-h, groups of slices, or partitions of a processor 300. In such an implementation, the execution engines 306a, 306b of the parallel processing resources of the processor 300 executing non-safety critical processing tasks may each be issued different tasks by their respective schedulers for efficiency of processing, while at least two of the execution engines 306a, 306b of the parallel processing resources of the processor 300 executing safety critical processing tasks are each issued the same task by their respective temporally synchronized schedulers for fault detection. In some implementations, all processing resources of the processor 300 are configured to execute safety critical processing tasks.

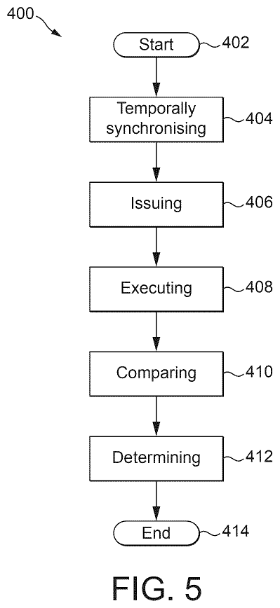

With reference to FIG. 5, there is illustrated a flowchart of a method 400 according to an approach of present techniques. The method 400 is a method of detecting a fault in a processor configured to perform parallel processing and comprising at least two parallel processing units, such as the processor 101 of FIG. 1, the processor 201 of FIG. 2 or the processor 300 of FIG. 4.

The method 400 is a machine implemented method 400. Where the machine is a computer, the method 400 may be a computer implemented method 400. Where the machine is a processor, such that the processor is performing self-diagnosis, the method 400 may be a processor implemented method 400. The method 400 is a method of detecting a fault. The fault may be a permanent fault or a transient fault.

The processor may be any processor configured to perform parallel processing and comprising at least two parallel processing units. For example, the processor may be a graphics processing unit, GPU. The processor may be any processor suitable for processing graphics. The processor may comprise a plurality of processing cores configured to operate in parallel. The processor may further comprise other components of processing, e.g., graphics processing, such as a ray-tracing unit or a texture unit.

The method 400 may comprise providing a processor configured to perform parallel processing. The method 400 may comprise providing a processor comprising at least two parallel processing units, each comprising a scheduler, and the processor further comprising comparison circuitry.

The method 400 starts at Start 402 and comprises, at step 404, temporally synchronizing respective schedulers of each of at least two parallel processing units to issue a same processing task to each of the at least two parallel processing units substantially simultaneously. At step 406, the method 400 comprises issuing, using the respective schedulers, the same processing task to each of the at least two parallel processing units substantially simultaneously. At step 408, the method 400 comprises executing, using each of the at least two parallel processing units, the same processing task to generate a respective output from each of the at least two parallel processing units. At step 410, the method 400 comprises comparing, using comparison circuitry, the respective outputs. Finally, at step 412, the method 400 comprises determining, responsive to a difference being detected between at least two of the respective outputs, that a fault is present in the processor. The method 400 ends at End 414.

Each of the at least two parallel processing units may be any unit of a processor configured to execute processing tasks in parallel with at least one further such unit. For example, the at least two parallel processing units may be execution engines of an execution core. In some examples, a processor may comprise between eight and 48 execution cores, each comprising a plurality of parallel processing units. In some examples, each execution core comprises between two and four parallel processing units.

A scheduler may be any hardware component of the processing unit configured to issue processing tasks to the parallel processing unit for execution. Each processing unit may comprise a respective scheduler.

The schedulers of the at least two parallel processing units are temporally synchronized to issue a same processing task to each of the at least two parallel processing units substantially simultaneously. In other words, the at least two parallel processing units are substantially synchronized in time. In this way, the parallel processing units may perform the same processing at substantially the same time and generate the respective outputs at substantially the same time. Accordingly, the respective outputs may be available for comparison using the comparison circuity at substantially the same time. In this way, a requirement for storing any of the respective outputs while corresponding respective outputs are generated is substantially alleviated. The respective schedulers may be synchronized to achieve lockstep operation of the at least two parallel processing units. In some implementations, the synchronizing is achieved by direct communication between schedulers. Additionally or alternatively, the synchronization may be performed by dedicated synchronization circuitry.

By issuing the same processing task to each of the at least two parallel processing units of the core at substantially the same time, the schedulers ensure that the at least two parallel processing units execute the same task at substantially the same time. Accordingly, if operating correctly, the parallel processing units will produce identical results at substantially the same time. Therefore, each of the respective outputs from each of the at least two parallel processing units should be substantially identical and available for comparison at substantially the same time. Comparison of the respective outputs may therefore be used detect a fault in at least one of the at least two parallel processing units.

While the schedulers may issue a same processing task to each of the at least two parallel processing units substantially simultaneously, the processing task may not be issued to each of the at least two parallel processing units at exactly the same time. Indeed there may be at least one clock cycle between a first scheduler issuing the processing task to a first parallel processing unit and a second scheduler issuing the processing task to a second parallel processing unit. In fact, a period between successive issuances of the processing task may be substantially longer than one clock cycle. For example, successive issuances of the processing task may be separated by up to 4 clock cycles. To maintain synchronization of the parallel processing units to enable meaningful comparison of respective outputs, the schedulers must be synchronized closely enough such that a series of respective outputs relating to a first processing task is not interrupted by a respective output relating to a second, different, processing task. To maintain processing efficiency, i.e., reduce delay caused by the period between successive issuances of the processing task, it is desirable to closely temporally synchronize the schedulers.

The method may comprise storing the respective outputs until all corresponding respective outputs have been generated and are therefore available for comparison. Each respective output may be stored, for example, by a buffer, cache or storage. Each respective output may be stored until comparison is complete.

By temporally synchronizing the at least two parallel processing units, a required duration of temporary storage of respective outputs may be minimised. Further, due to the synchronizing, none of the at least two parallel processing units may generate an output to a different processing task between consecutive comparison events.

The processing task may comprise a portion of a job or workload allocated to the at least two parallel processing units. The processing task may be any suitable processing task for execution by the processor. For example, the processing task may be a graphics processing task, e.g., a pixel value calculation for an image.

The processing task may be a safety critical processing task. For example, the safety critical processing task may be to process camera data in an adaptive cruise control system in a vehicle. As another example, the safety critical processing task may be to process data in an autonomous emergency braking system. Such a safety critical processing task may use machine learning and data from a plurality of sensors to decide whether to boost brake pedal effect or even apply the brakes without driver demand. Other advanced driver assistance systems may also include examples of safety critical processing tasks and safety critical machine learning processing tasks.

The comparison circuitry may be any hardware circuitry configured to compare the respective outputs of the at least two parallel processing units and provide an indication of identity (or equality) or lack thereof. The comparison circuitry may be configured to receive as inputs the respective outputs of the at least two parallel processing units. The comparison circuitry may be configured to generate an output indicative of whether the inputs are equal or not. For example, the comparison circuitry may be configured to generate a first output value if the inputs are equal, and generate a second, different output value if the inputs are unequal.

Once a value indicative of (non-)identity, or (in)equality, is generated by the comparison circuitry, the presence or absence of a fault in the core is determined. In particular, if the value generated by the comparison circuitry indicates that the respective outputs from the at least two parallel processing units were not substantially identical, i.e., a difference was detected, it may be determined that a fault is present in at least one of the parallel processing units.

Alternatively, if the value generated by the comparison circuitry indicates that the respective outputs from the at least two parallel processing units were substantially identical, i.e., no difference was detected, it may be determined that no fault is detected in any of the parallel processing units. While no fault may be detected as a result of executing the processing task, it will be understood that, in practice, no single processing task will exercise all the logic in a processing unit. So, in such a scenario, no faults may be present or a fault may yet be present and undetected in a portion of the processing unit not exercised by the processing task. Until a processing task is executed that exercises the faulty portion, the fault may be latent, i.e., undetected. Accordingly, if the value generated by the comparison circuitry indicates that the respective outputs from the at least two parallel processing units were substantially identical, i.e., no difference was detected, it may not necessarily be accurate to determine that no fault is present. However, it is highly likely to be accurate to determine that no error is present in the respective output, as the chances of the at least two parallel processing units all suffering a fault to produce the same erroneous output is very low. The determination that a fault is, or is not, detected may be performed by the comparison circuitry.

The processor may further comprise fault reporting circuitry. The determination that a fault is, or is not, detected may be performed by the fault reporting circuitry. For example, the fault reporting circuitry may communicate with the comparison circuitry to determine detection, or not, of a fault. The fault reporting circuitry may comprise hardware configured to signal detection of a fault (or a fault-free status) out of the processing unit or the core. The fault reporting circuitry may signal detection of a fault to a processing unit manager or a processor manager of the processor such as a command stream front end unit or an access manager unit. Once reported to a manager unit, the fault may trigger mitigation action. For example, a mitigation action may include removal of the faulty core from a resource pool and/or de-allocation of workload to the faulty core.

Determining that a fault is present in the core may comprise sending, to a fault mitigation circuit or system, an indication that a fault is detected in the core. The indication that a fault is detected may include an indication of a location within the processor of the fault, e.g., an identifier of the core or an identifier of the at least two parallel processing units of the core.

The fault may be a permanent fault or a transient fault. A transient fault may be a fault that is automatically resolved within a predetermined time interval; that is not replicable or reproducible. For example, a pair of processing units with a transient fault, when issued with the same processing task a further time, may generate identical respective outputs following an initial generation of non-identical respective outputs. A transient fault may be a fault that does not cause a permanent change of state i.e. does not cause permanent damage to the circuitry/logic involved. A transient fault may be resolved by reinitialization and repetition of the processing task. A transient fault may be a fault that is observed infrequently, e.g., falling below a predetermined threshold number of occurrences in a time period.

A permanent fault may be any fault that is not transient. For example, a permanent fault may be a fault that is not automatically resolved within a predetermined time interval, e.g., a fault that is detected continuously throughout a predetermined time interval, or, in other words, a fault whose absence is not detected at any point in the predetermined time interval. A permanent fault may be a fault that causes a permanent change of state, i.e., causes permanent damage to the logic/circuitry involved such that it cannot be returned to its previous state. In practice, a permanent fault may be a fault that, once detected, is reliably detected; a fault that is readily replicated or reproduced. A permanent fault may be a hardware fault, e.g., a failed circuit device such as a failed transistor. A processor may develop permanent faults through normal use, i.e., aging or wear and tear.

A permanent fault may be any fault that indicates a permanent problem within the parallel processing unit, e.g., a fault that indicates that the parallel processing unit is unreliable and should not be used. Such unreliability may be caused by a reduced processing speed, for example. In these cases, a permanent fault may not be detected continuously throughout a predetermined time interval but may instead be detected periodically throughout a predetermined time interval. For example, detection of a number of transient faults exceeding a predetermined threshold within a time period may qualify as a permanent fault in a processing unit.

Respective outputs from each of the at least two parallel processing units that are not substantially identical may be a reliable indicator of a fault in at least one of the parallel processing units of the core of the processor because the parallel processing units were issued the same task and so therefore ought to have produced the same result. Accordingly, different results indicate that at least one of the respective outputs must be incorrect and a corresponding at least one of the parallel processing units must have a fault. In this way, the method of present techniques may reliably detect a fault in a processor.

Where more than two parallel processing units are used and a difference is found between the respective outputs such that a fault is detected in at least one of the parallel processing units, it may be possible to isolate the fault to one of the parallel processing units. Specifically, where one of the parallel processing units generates a respective output that differs from all the other respective outputs, it may be determined that a fault is present in the one parallel processing unit because the remaining plurality are in consensus.

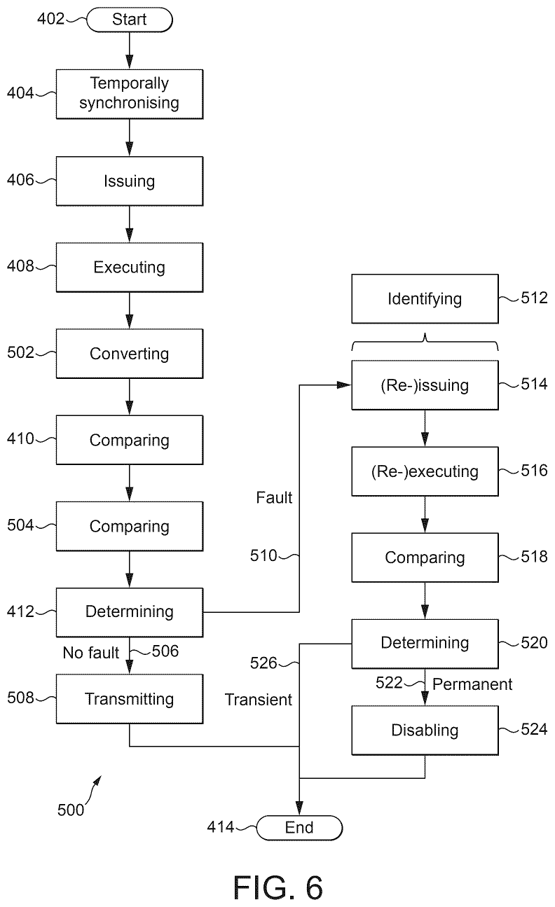

With reference to FIG. 6, there is illustrated a flowchart of a method 500 according to an approach of present techniques. The method of FIG. 6 comprises all the steps of the method of FIG. 5. The shared steps are indicated with like reference numerals and not described in detail again.

As for the method 400, the method 500 is a method of detecting a fault in a processor, such as the processor 101 of FIG. 1, the processor 201 of FIG. 2 or the processor 300 of FIG. 4.

The method 500 starts at Start 402 and comprises, at step 404, temporally synchronizing respective schedulers of at least two parallel processing units of the processor to issue a same processing task to each of the at least two parallel processing units substantially simultaneously. At step 406, the method 500 comprises issuing, using the respective schedulers, the same processing task to each of the at least two parallel processing units of the processor substantially simultaneously. At step 408, the method 500 comprises executing, using each of the at least two parallel processing units, the same processing task to generate a respective output from each of the at least two parallel processing units.

At step 502, the method 500 comprises converting the respective outputs from each of the at least two parallel processing units into respective output hashes for comparison. By converting the respective outputs to respective output hashes, the step of comparing, using comparison circuitry, may be simplified. In this way, an efficiency of the method may be increased. In this way, the comparison may be simpler and more efficient.

At step 410, the method 500 comprises comparing, using comparison circuitry, the respective output hashes. The comparing step 410 may be followed by further a comparing step 504. At step 504, the method 500 comprises comparing, using the comparison circuitry, inputs to a non-parallelized module of the core to each of the at least two parallel processing units and/or comparing, using the comparison circuitry, outputs from the non-parallelized module to each of the at least two parallel processing units. The inputs to and/or outputs from the non-parallelized module may have been received by the comparison circuitry during a receiving step (not shown). By comparing inputs to and/or outputs from the non-parallelized module, transient faults in the non-parallelized module may be detected. In this way, different respective outputs found at the comparing step 504 may be attributed to the non-parallelized module. In this way, the method 500 may enable pinpoint diagnosis of faults in the core.

A non-parallelized module of the core may be any component of the processor which is not duplicated. That is, the non-parallelized module of the processor may be any component which is not operating in parallel with another such component to execute a processing task. A non-parallelized module may be a fixed function module configured to perform processing tasks corresponding to a fixed function, e.g., ray-tracing. The non-parallelized unit may be configured to operate substantially in series with each of the at least two parallel processing units of the processor. In some cases, the non-parallelized module is any component of the core that is not one of the at least two parallel processing units. For example, the non-parallelized module may be a warp manager, ray-tracing unit, an attribute unit or a texture unit.

By comparing inputs to and/or outputs from a non-parallelized module to each of the at least two parallel processing units, the method 500 may be used to detect transient faults in the non-parallelized module. For example, if the inputs to the non-parallelized module are identical but the outputs are different, a difference detected between respective outputs of the at least two parallel processing units may be attributed to a fault in the non-parallelized module. In some cases, for example, where a frequency of transient faults in a non-parallelized module exceeds a predetermined threshold, the non-parallelized module may be considered unsuitable for use. In such a case, the remainder of the core may yet be useable for tasks which do not require the non-parallelized module in which the transient fault is detected. For example, if a texture mapper is faulty, the core may still be suitable to execute non-graphics rendering processing.

All messages to and from the at least two parallel processing units may be compared with their respective counterparts to pinpoint a time and/or location of deviation of the processing of each unit from other units.

In cases where no difference is found at comparing step 410, when comparing respective output hashes, there may be no need to perform comparing step 504, comparing inputs to and/or outputs from a non-parallelized module to each of the at least two parallel processing units. In that case, immediately after comparing step 410, may come determining step 412. However, where a difference is found at comparing step 410, comparing step 504 may be performed to attempt to identify a location of the fault causing the difference.

Next, at step 412, the method 500 comprises determining, responsive to a difference being detected between at least two of the respective outputs, that a fault is present in the processor. Step 412 may also include determining, responsive to no difference being detected between at least two of the respective outputs, that no fault is detected in the processor.

At step 412, the method may further comprises determining, responsive to a difference being detected between the respective inputs to, and/or outputs from, the non-parallelized fixed function processing circuit, that a fault is present in the processor. In this way, it may be determined that a transient fault exists in the non-parallelized module.

If no difference is detected between at least two of the respective outputs, no fault is detected. Accordingly, route 506 is followed from determining step 412. Route 506 leads to, at step 508, transmitting, by one of the at least two parallel processing units, a message to storage. Following message transmission, the method 500 ends at step 414.

The parallel processing unit that transmits a message out of the core may be a primary parallel processing unit of the at least two parallel processing units. Other parallel processing units of the at least two parallel processing units may be secondary or tertiary parallel processing units. The secondary or tertiary parallel processing units may be configured to process tasks to generate respective outputs for comparison only.

If, at determining step 412, a difference is detected between at least two of the respective outputs, it is determined that a fault is present in the core. Accordingly, route 510 is followed from determining step 412. Route 510 leads to, at bracketing step 512, identifying that the fault is a permanent fault. Identification of the fault as a permanent fault may determine mitigation action of the processor.

Route 510 leads to the first sub step 514 of bracketing step 512. Identifying that the fault is a permanent fault, bracketing step 512, comprises, at step 514, re-issuing the processing task to each of the at least two parallel processing units. Step 514 may alternatively include issuing, using the schedulers, a diagnostic task to each of the at least two parallel processing units.

Next, at step 516, the method 500 comprises re-executing the processing task to regenerate a respective output from each of the at least two parallel processing units. Where step 514 included issuing the diagnostic task, step 516 may alternatively include executing, using each of the at least two parallel processing units, the diagnostic task to generate a respective diagnostic output from each of the at least two parallel processing units.

Following the re-executing of the processing task, the method 500 comprises, at step 518, comparing, using the comparison circuitry, the respective outputs with the regenerated respective outputs. Alternatively, following the executing of the diagnostic task, the method 500 comprises, at step 518, comparing, using comparison circuitry, the respective diagnostic outputs.

Following comparison, the method 500 comprises, at step 520, determining that the fault is a permanent fault. Where step 518 included comparing the respective outputs with the regenerated respective outputs, the determining at step 520 is responsive to the regenerated respective outputs corresponding to the respective outputs. Where step 518 included comparing the respective diagnostic outputs, the determining at step 520 is responsive to a difference being detected between at least two of the respective diagnostic outputs.

As discussed above, a permanent fault may be any fault that is not transient and/or any fault that indicates a permanent problem within the processing unit. In practice, a permanent fault may be a fault that, once detected, is reliably detected. Accordingly, when a permanent fault is present, any further execution of processing tasks by the affected parallel processing unit may result in faulty, or corrupt, outputs. Therefore, when a permanent fault is present, the affected processing unit may be removed from use, e.g., disabled, deactivated or removed from a resource pool by updating a list, for example, in storage, of available resources.

Identifying 512 that the fault is a permanent fault may comprise: re-issuing 514 the processing task to each of the at least two parallel processing units; re-executing 516 the processing task to regenerate a respective output from each of the at least two parallel processing units; comparing 518, using the comparison circuitry, the respective outputs with the regenerated respective outputs; and determining 520, responsive to the regenerated respective outputs corresponding to the respective outputs, that the fault is a permanent fault.

In other words, identifying 512 that the fault is a permanent fault comprises executing the same processing task again and comparing the subsequent outputs with the original outputs. If a fault was found in the original outputs, and the subsequent outputs match the original outputs, it may be determined that there is a permanent fault. Conversely, if a fault was found in the original outputs, and the subsequent outputs match one another and not the original outputs, it may be determined that there is not a permanent fault. Between subsequent executions, of the same processing task, the at least two processing units may be re-initialised to reset the units and avoid the first fault affecting the subsequent execution.

Additionally or alternatively, identifying 512 that the fault is a permanent fault may comprise issuing and executing a subsequent same processing task and comparing the subsequent outputs to determine whether a fault is present in the core. If a subsequent fault is found, it may indicate the presence of a permanent fault.

Additionally or alternatively, identifying 512 that the fault is a permanent fault may comprise determining that a number of times that a fault has been detected during a predetermined time period exceeds a predetermined threshold. In this case, each individual fault detected may itself be transient, i.e., not repeatable, but the frequency with which transient faults occur may indicate presence of a permanent fault, making the processing units unsuitable for further use.

Additionally or alternatively, identifying 512 that the fault is a permanent fault comprises: issuing 514, using the schedulers, a same diagnostic task to each of at least two parallel processing units; executing 516, using each of the at least two parallel processing units, the same diagnostic task to generate a respective diagnostic output from each of the at least two parallel processing units; comparing 518, using comparison circuitry, the respective diagnostic outputs; and determining 520, responsive to a difference being detected between at least two of the respective diagnostic outputs, that the fault is a permanent fault.

In this case, when a fault is detected, the affected at least two parallel processing units are issued a same diagnostic task to determine the type of fault present (i.e., transient or permanent). If a fault can be reproduced then it may be deemed to be permanent, if not then it may be deemed to be transient.

The diagnostic task may be a predetermined task configured to exercise a majority of the circuitry of the parallel processing units when executed. If the diagnostic task is a predetermined task, it may have a predetermined correct result. Therefore, by comparing the respective outputs of the at least two parallel processing units against the predetermined correct result, the fault may be pinpointed to one or more of the at least two parallel processing units.

The diagnostic task may comprise an engineered pseudorandom pattern configured to achieve high diagnostic coverage of the circuity of the parallel processing unit executing the task. The diagnostic task may comprise a pseudorandom stimulus generated by a pseudorandom stimulus generator and configured to, when executed by each of the at least two parallel processing units, exercise a majority of the circuitry of each of the at least two parallel processing units.

Due to the size of the state-space, it is possible that faults may exist in the processor that are not found during a periodic logic built-in self-test (LBIST) sweep. These faults may be in hardware that is exercised during processing, but not diagnosis via the LBIST protocol. As such, the faults may appear in processed outputs and be detected during comparison step 410/determining step 412.

After presence of a fault is determined due to a difference between respective outputs being detected, the nature, or severity, of the fault must be determined, e.g., to inform mitigation. To determine that the fault is permanent, it must be replicated. Replication by executing a diagnostic task configured to exercise a majority of the circuitry of each of the at least two parallel processing units may be successful in replicating the fault if the diagnostic task exercises the faulty circuitry. However, this may not always be the case and permanent faults may go un-identified or mis-identified due to generic diagnostic tasks or diagnosis protocols, e.g., LBIST.

The specific processing task, or program, being executed at the time that the respective outputs fail a comparison test, i.e., a difference is detected between the respective outputs, may be known and retrieved/stored. Executing a diagnostic task that bears a technical resemblance to that specific processing task may increase a probability that, if a permanent fault exists, it is found. Accordingly, biasing the diagnostic task towards the processing task may enable more reliable fault identification.

To improve a likelihood of the diagnostic task exercising the faulty portion of the faulty processing unit of the at least two parallel processing units, the diagnostic task may be biased towards the processing task during execution of which the fault was first detected. Specifically, the pseudorandom stimulus generator may be tuned to generated a skewed pseudorandom stimulus that more closely approximates the processing task than the stimulus of the unbiased diagnostic task.

The pseudorandom stimulus generator may be tuned in any suitable way. For example, the generator may be configured to generate a plurality of different types of stimuli according to a ratio of types. If the processing task being executed when the fault was first detected is of a first type, the ratio may be biased so that more stimuli of the first type are generated by the generator. The tuning may be multidimensional, e.g., various attributes of the processing task may correlate to various types of stimulus, and so different bias, or skew, may be applied to different stimuli.

Considering a simplified case of a first logic that is enabled by a two-input AND gate, and a separate second logic that is enabled by a two-input OR gate, it may be desirable to trigger (i.e., cause a high (1) output) from the first and second logic at an equal rate. In this way, operation of the logic may be verified and subsequent, e.g., downstream, logic may be exercised. In order to achieve substantially equal triggering of the first and second logic, a higher rate of high (1) inputs must be provided to the first logic, enabled by AND, than to the second logic, enabled by OR. That is, given a uniform random distribution of inputs, the OR output is triggered 75% of the time, i.e., by 75% of the pseudorandom stimuli (patterns ‘01’, ‘10’ and ‘11’), whereas the AND logic is triggered only 25% of the time, i.e., by 25% of the pseudorandom stimuli (pattern ‘11’ only). So, to achieve substantially equal triggering of the first and second logic, the pseudorandom stimulus generator may be tuned to provide more ‘11’ pattern stimuli to the first logic, rather than a uniform distribution of inputs.

Alternatively, should the processing task used to bias the diagnostic task involve substantially disabling the first logic, e.g., by providing a low (0) input to that logic, the pseudorandom stimulus generator may be tuned to provide fewer ‘11’ pattern stimuli to the first logic, rather than a uniform distribution of inputs. Subsequently, the functional path when the output from the first logic, triggered by AND, is zero is more common. In short, where a particular logic operation is executed, and therefore corresponding particular hardware is exercised, often in execution of a processing task, a diagnostic task biased towards that particular logic operation and/or that particular hardware may be used in fault diagnosis.

It will be understood by the skilled person that the above example is substantially simplified and that an implementation in software may be substantially more advanced; providing finely tuned stimuli in an automated manner based on a model of the logic of the at least two parallel processing units and algorithmic behaviour engineered in advance.

It may not be desirable to use a skewed pseudorandom stimulus in the diagnostic task in every scenario. In particular, adjusting the bias, or skew, may invalidate predetermined coverage estimates and instead examine a potentially narrow range of states in the state-space. In this way, a biased diagnostic task may not exercise as large a majority of the circuitry of the at least two parallel processing units as an unbiased diagnostic task. On the other hand, biasing the diagnostic task may enable a determination of the nature of a fault to be made very quickly. Accordingly, a biased diagnostic task may be used if the broad coverage of an unbiased diagnostic task has been unsuccessful in detecting the fault. For example, a biased diagnostic task may be used following determination that a number of times that a fault has been detected during a predetermined time period exceeds a predetermined threshold, but an unbiased diagnostic task has found no fault. Alternatively, a biased diagnostic task may be used where it is suspected that a fault exists in a specific portion of the logic. In this case, an extreme bias, even totally excluding logic that is not of instant interest from diagnosis, may be acceptable. An unbiased diagnostic task may be used where broad coverage, e.g., as can be achieved with a fixed/optimised pattern generator, is also periodically required.

Initial diagnosis using the diagnostic task may not use a biased task so that a majority of the circuitry of each of the at least two parallel processing units is exercised during diagnosis. If a number of times that a fault has been detected during a predetermined time period exceeds a predetermined threshold, i.e., a fault is found and determined to be transient via diagnosis a greater number of times in a time period than is acceptable, the diagnostic task may be biased to improve effectiveness of detection of the fault, improving an accuracy of diagnosis to find the source of the persistent, and therefore likely permanent, fault. In this way, faults in infrequently exercised portions of the processing hardware may be found.

Tuning based on the processing task may be an iterative process, e.g., the diagnostic task may be executed, tuned, re-executed, re-tuned, etc. until a fault is found or an iteration limit is reached. In this way, a plurality of parameters of the pseudorandom stimulus generator may be tuned based on a plurality of attributes of the processing task. After execution, a pseudorandom stimulus may not be stored or saved. In this way, the pseudorandom stimulus may require fewer storage, e.g., memory, resources than a predetermined stimulus.

Finally, if at step 520 it is determined that the fault is a permanent fault, either by re-processing the processing task or processing the diagnostic task, route 522 is followed such that the next step is step 524. At step 524, the method 500 comprises disabling at least one of the at least two parallel processing units.

At step 524, the method 500 may comprise disabling at least one of the at least two parallel processing units. For example, responsive to a fault being detected in at least one of the at least two parallel processing units, at least one of the at least two parallel processing units may be disabled. In some cases, only one parallel processing unit is disabled, for example, the parallel processing unit in which the fault is present. In some cases, all of the at least two parallel processing units may be disabled. In some cases, for example, where the at least two parallel processing units constitute all the processing units of a core, the method may comprise disabling the core.

Disabling a parallel processing unit may comprise halting all further issuance of processing tasks to the parallel processing unit. For example, this may be achieved by removing the parallel processing unit from a resource pool by updating a list, e.g., in storage, of available resources. In other cases, disabling a parallel processing unit may comprise halting all further issuance of non-diagnostic processing tasks to the parallel processing unit.

Alternatively, if at step 520 it is determined that the fault is not a permanent fault (i.e., the fault is a transient fault), route 526 is followed to the end of method 500 at step 414. If a transient fault is found, a counter may be incremented such that a number and/or frequency of transient faults may be measured.

In an alternative implementation, identifying 512 that the fault is a permanent fault at step 512 merely comprises determining 520 that a number of times that a fault has been detected during a predetermined time period exceeds a predetermined threshold. In that case, the steps of (re-)issuing 514, (re-)executing 516 and comparing 518 may be omitted.

As such, method 500 has three routes between Start 402 and End 414. Specifically, if no fault is detected at determining step 412, End 414 is reached via route 506 and transmitting step 508. If a fault is detected at determining step 412 the identifying 512 workflow is entered. If the fault is determined to be a permanent fault at determining step 520, End 414 is reached via route 522 and disabling step 524. If the fault is determined not to be a permanent fault at determining step 520, End 414 is reached via route 526.

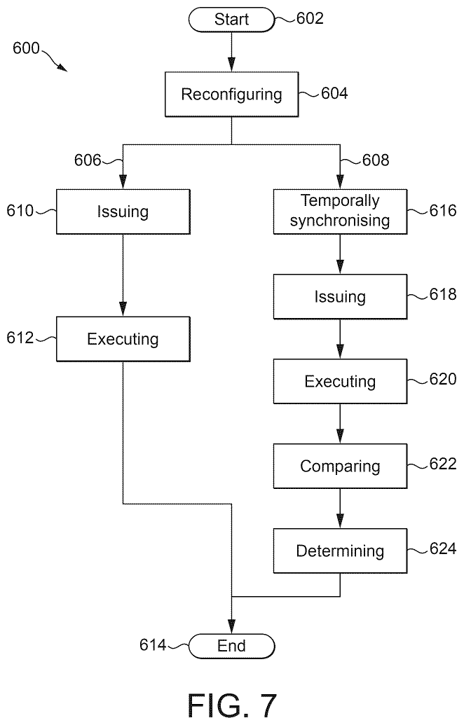

With reference to FIG. 7, there is illustrated a flowchart of a method 600 according to a further approach of present techniques. The method 600 is a method of detecting a fault in a processor configured to perform parallel processing, such as the processor 101 of FIG. 1, the processor 201 of FIG. 2 or the processor 300 of FIG. 4. The processor may comprise at least two parallel processing units, each parallel processing unit comprising a respective scheduler.

The method 600 starts at Start 602 and comprises, at step 604, reconfiguring the processor between a non-safety critical configuration, by following route 606, and a safety-critical configuration, by following route 608. The reconfiguration may be initiated by a manager, such as an access manager, of the processor.

In the non-safety critical configuration, the method 600 comprises, at step 610, issuing, using respective schedulers, a plurality of respective non-safety critical processing tasks among each of at least two parallel processing units of the processor, respectively. Next, at step 612, the method 600 comprises executing, using each of the at least two parallel processing units, the respective non-safety critical processing tasks. Then, the method 600 ends at End 614.

In the safety critical configuration, the method 600 comprises, at step 616, temporally synchronizing respective schedulers of at least two parallel processing units to issue a same processing task to each of the at least two parallel processing units substantially simultaneously. Next, at step 618, the method 600 comprises issuing, using the respective schedulers, the same processing task to each of the at least two parallel processing units of the processor substantially simultaneously. Following issuing, at step 620, the method 600 comprises executing, using each of the at least two parallel processing units, the same processing task to generate a respective output from each of the at least two parallel processing units. At step 622, the method 600 comprises comparing, using comparison circuitry, the respective outputs. Finally, at step 624, the method 600 comprises determining, responsive to a difference being detected between at least two of the respective outputs, that a fault is present in the reconfigurable processor. After the determining step 624, the method 600 ends at End 614.

In an alternative implementation of the method 600 of FIG. 7, the reconfiguring step 604 may allow the processor to be reconfigured into a further configuration; a diagnostic configuration. The diagnostic configuration is similar to the safety critical configuration except that a diagnostic task is issued and executed, rather than a processing task from a workload of the processor. In the diagnostic configuration, the steps 616-624 are performed with a diagnostic task. The diagnostic task may comprise a pseudorandom stimulus configured to, when executed by each of the parallel processing units, exercise a majority of the circuitry of the parallel processing units to achieve broad diagnostic coverage. Alternatively, the diagnostic task may comprise a skewed pseudorandom stimulus configured to bias the diagnostic task towards the processing task during execution of which a fault was detected in order to replicate the fault.

In this way, the method 600 allows a processor to operate in a safety critical configuration for fault detection, a non-safety critical mode for efficiency and periodically, or in response to a fault, in a diagnostic mode for periodic or ad hoc determination of the presence or nature of faults.

As will be appreciated by one skilled in the art, the present technology may be embodied as a method, a circuit or a computer readable medium comprising data and imperatives to cause construction of a circuit. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally, or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively, or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to...” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A machine implemented method of detecting a fault in a processor configured to perform parallel processing, the processor comprising at least two parallel processing units, the method comprising:
temporally synchronizing respective schedulers of each of the at least two parallel processing units to issue a same processing task to each of the at least two parallel processing units substantially simultaneously;
issuing, using the respective schedulers, the same processing task to each of the at least two parallel processing units substantially simultaneously;
executing, using each of the at least two parallel processing units, the same processing task to generate a respective output from each of the at least two parallel processing units;
comparing, using comparison circuitry, the respective outputs; and
determining, responsive to a difference being detected between at least two of the respective outputs, that a fault is present in the processor.

2. The method of claim 1, wherein the processor further comprises at least one non-parallelized fixed function processing circuit comprising circuitry configured to operate substantially in series with each of the at least two parallel processing units of the processor to perform processing tasks corresponding to a fixed function.

3. The method of claim 2, further comprising comparing, using the comparison circuitry, respective inputs to the non-parallelized fixed function processing circuit from each of the at least two parallel processing units; and
determining, responsive to a difference being detected between the respective inputs to the non-parallelized fixed function processing circuit, that a fault is present in the processor.

4. The method of claim 3, further comprising comparing, using the comparison circuitry, respective outputs from the non-parallelized fixed function processing circuit to each of the at least two parallel processing units; and
determining, responsive to a different being detected between the respective outputs from the non-parallelized fixed function processing circuit, that a fault is present in the processor.

5. The method of claim 1, wherein further comprising identifying that the fault is a permanent fault by:
issuing, using the schedulers, a diagnostic task to each of the at least two parallel processing units;
executing, using each of the at least two parallel processing units, the diagnostic task to generate a respective diagnostic output from each of the at least two parallel processing units;
comparing, using comparison circuitry, the respective diagnostic outputs; and
determining, responsive to a difference being detected between at least two of the respective diagnostic outputs, that the fault is a permanent fault.

6. The method of claim 5, wherein the diagnostic task comprises a pseudorandom stimulus generated by a pseudorandom stimulus generator and configured to, when executed by each of the at least two parallel processing units, exercise a majority of the circuitry of each of the at least two parallel processing units.

7. The method of claim 6, further comprising tuning at least one parameter of the pseudorandom stimulus generator based on at least one attribute of the processing task to generate a skewed pseudorandom stimulus to bias the diagnostic task towards the processing task.

8. The method of claim 7, wherein the at least one attribute of the processing task is one or more selected from the list: an instruction type; an instruction class.

9. The method of claim 7, wherein the pseudorandom stimulus generator is tuned based on the processing task in response to determining that a number of times that a fault has been detected during a predetermined time period exceeds a predetermined threshold.

10. A processor configured to perform parallel processing, the processor comprising:
at least two parallel processing units, each parallel processing unit comprising a respective scheduler;
the respective schedulers being temporally synchronizable to issue a same processing task to each respective one of the at least two parallel processing units substantially simultaneously;
the parallel processing units being configured to execute the same processing task to each generate a respective output; and
comparison circuitry configured to compare the respective outputs to determine, responsive to a difference being detected between at least two of the respective outputs, that a fault is present in the processor.

11. The processor of claim 10, wherein the processor is dynamically re-configurable between:
a safety critical configuration, in which the respective schedulers are temporally synchronized to issue a same safety critical processing task to each respective one of the at least two parallel processing units substantially simultaneously; and
a non-safety critical configuration, in which the respective schedulers are not temporally synchronized and are configured to issue respective non-safety critical processing tasks to the respective parallel processing units, and in which the respective outputs are not compared by the comparison circuitry.

12. The processor of claim 10, wherein the at least two parallel processing units each comprise programmable processing circuitry operable to execute programs to perform processing tasks.

13. The processor of claim 10, comprising a first execution core comprising the at least two parallel processing units, and a further execution core comprising a further at least two parallel processing units;
the first execution core being configured to operate substantially in parallel with the further execution core to substantially simultaneously execute respective processing tasks of a processor workload.

14. The processor of claim 10, comprising a first execution module comprising the first execution core and the second execution core, and a second execution module comprising at least two further execution cores;
the first execution module being configured to operate substantially in parallel with the second execution module to substantially simultaneously execute respective processing task streams of the processor workload.

15. The processor of claim 10, comprising a command stream execution unit configured to issue commands relating to processing tasks to cause the processing tasks indicated by the commands to be distributed to the schedulers of each of the at least two parallel processing units.

16. The processor of claim 10, wherein the at least two parallel processing units comprises a primary parallel processing unit and a secondary parallel processing unit;
the primary parallel processing unit being configured to transmit, responsive to no difference being detected between the respective outputs of the primary parallel processing unit and the secondary parallel processing unit, a message comprising the respective output of the primary parallel processing unit to storage.

17. The processor of claim 16, wherein the message further comprises a fault-free indicator.

18. The processor of claim 16, wherein the at least two parallel processing units further comprises a tertiary parallel processing unit;
the primary parallel processing unit being configured to transmit, responsive to no difference being detected between the respective outputs of the primary parallel processing unit and one other of the secondary parallel processing unit and the tertiary parallel processing unit, a message comprising the respective output of the primary parallel processing unit to storage.

19. A reconfigurable processor configured to perform parallel processing and operable to be reconfigured between a safety critical configuration and a non-safety critical configuration, the processor comprising:
at least two parallel processing units, each parallel processing unit comprising a respective scheduler;
wherein, in the non-safety critical configuration, the respective schedulers are configured to issue respective non-safety critical processing tasks to the respective parallel processing units for execution; and
wherein, in the safety critical configuration:
the respective schedulers are temporally synchronized to issue a same safety critical processing task to each respective one of the at least two parallel processing units substantially simultaneously;
the parallel processing units are configured to execute the same processing task to each generate a respective output; and
comparison circuitry is configured to compare the respective outputs to determine, responsive to a difference being detected between at least two of the respective outputs, that a fault is present in the reconfigurable processor.

20. The reconfigurable processor of claim 19, wherein the processor is further operable to be reconfigured into a diagnostic configuration;
wherein, in the diagnostic configuration, the respective schedulers are configured to issue a same diagnostic task to each of the at least two parallel processing units for execution;
the diagnostic task comprising a predetermined stimulus configured to, when executed by each of the at least two parallel processing units, exercise a majority of the circuitry of the parallel processing units.
